(19) United States
(12) Patent Application Publication
(10) Pub. No.: US 2016/0069502 A1
(43) Pub. Date: Mar. 10, 2016

(54) SUPPORT LINER

(71) Applicants: James A. MACIAK, Erie, PA (US); Keith R. PTAK, Erie, PA (US); LORD CORPORATION, Cary, NC (US)

(72) Inventors: James A. MACIAK, Erie, PA (US); Keith R. PTAK, Erie, PA (US)

(21) Appl. No.: 14/784,517

(22) PCT Filed: May 1, 2014
(86) PCT No.: PCT/US14/36377

§ 371 Date: Oct. 14, 2015

Related U.S. Application Data
(60) Provisional application No. 61/817,955, filed on May 1, 2013.

(51) Int. Cl. F16L 58/00; F16L 3/26; F16L 3/02

(52) U.S. Cl. CPC F16L 58/00; F16L 3/02; F16L 3/26

(57) ABSTRACT

A pipeline corrosion control system may include a pipeline (102), a saddle (118) configured to provide support to the pipeline, and a support liner (200) having a tapered top side (206) and a substantially flat bottom side (208), wherein a plurality of grooves (214) are disposed in the top side of the support liner, and wherein the support liner is disposed between the pipeline and the saddle with the top side of the support liner associated with the pipeline and the bottom side of the support liner being associated with the saddle.

### CROSS-REFERENCE TO RELATED APPLICATION

This application relates to and claims priority to U.S. Provisional Patent Application Ser. No. 61/817,955, filed on May 1, 2013, the disclosure of which is fully incorporated herein by reference, in the entirety.

### BACKGROUND

Long distance pipelines, such as hydrocarbon delivery pipelines, may often be subjected to extreme environmental conditions, which may include extreme temperatures, humidity, and/or moisture exposure. Some traditional pipelines utilize galvanized sheathing that is spiral-wound around a rigid foam insulation to insulate the pipeline. Such traditional pipelines are generally supported by a galvanized steel support structure called a saddle. Due to the exposure to varying extreme environmental conditions, traditional pipelines are often designed to account for expansion and contraction, where the pipeline moves relative to the supportive saddle. Often, moisture becomes trapped between the insulation and the saddle, which may cause corrosion of the saddle and/or the galvanized sheathing on the pipeline.

As the saddle and/or the galvanized sheathing corrodes, moisture becomes entrapped within the foam insulation causing the galvanized sheathing to deform. Additionally, fluid flowing through the pipeline and/or external environmental forces, such as wind, may cause vibrations. Repairing damaged and/or corroded pipelines is expensive and labor-intensive. Accordingly, there is a need for a support liner in a pipeline system that provides corrosion control between a pipeline and a support saddle in varying extreme environmental conditions, while also providing vibration damping control to reduce and/or eliminate vibrations between the pipeline and support saddle to further control and/or prevent corrosion damage.

### SUMMARY

In some embodiments of the disclosure, an elastomeric support liner is disclosed as comprising a top side; and a bottom side; wherein a plurality of grooves are disposed in the top side of the support liner; and wherein the support liner is formed from an elastomeric material having a wet static coefficient of friction of at least about 0.35.

In other embodiments of the disclosure, a pipeline corrosion control system is disclosed, comprising: a pipeline; a saddle; and a support liner comprising a top side and a bottom side; wherein a plurality of grooves are disposed in the top side of the support liner; and wherein the support liner is formed from an elastomeric material having a wet static coefficient of friction of at least about 0.35.

### BRIEF DESCRIPTION OF THE DRAWINGS

FIG. 1 is an oblique view of a pipeline system according to an embodiment of the disclosure.

FIG. 2 is an orthogonal cross-sectional front view of a support liner according to an embodiment of the disclosure.

FIG. 3 is an orthogonal top view of a support liner according to an embodiment of the disclosure.

FIG. 4 is an orthogonal cross-sectional front view of a support liner according to an alternative embodiment of the disclosure.

FIG. 5 is an orthogonal top view of a support liner according to an alternative embodiment of the disclosure.

FIG. 6 is an orthogonal cross-sectional front view of a support liner according to another alternative embodiment of the disclosure.

FIG. 7 is an orthogonal top view of a support liner according to another alternative embodiment of the disclosure.

### DETAILED DESCRIPTION

In some cases, it may be desirable to provide a corrosion control system in a long distance pipeline system to reduce and/or prevent corrosion of the pipeline system components. For example, where a pipeline system is subjected to extreme environmental conditions, such as a combination of extreme temperatures, humidity, and/or moisture make it desirable to provide a corrosion control system. Preferably, the corrosion control system includes an elastomeric support liner disposed between the pipeline and the support saddle thereby providing corrosion control therebetween in varying extreme environmental conditions. This configuration also provides vibration-damping control to reduce and/or eliminate vibration between the pipeline and the saddle, thereby further controlling and/or preventing corrosion damage to the pipeline system components. In some embodiments, systems and methods are disclosed that comprise providing an elastomeric support liner in a corrosion control system. In some embodiments, the support liner may be a component of a corrosion control system used in a long distance hydrocarbon production pipeline system.

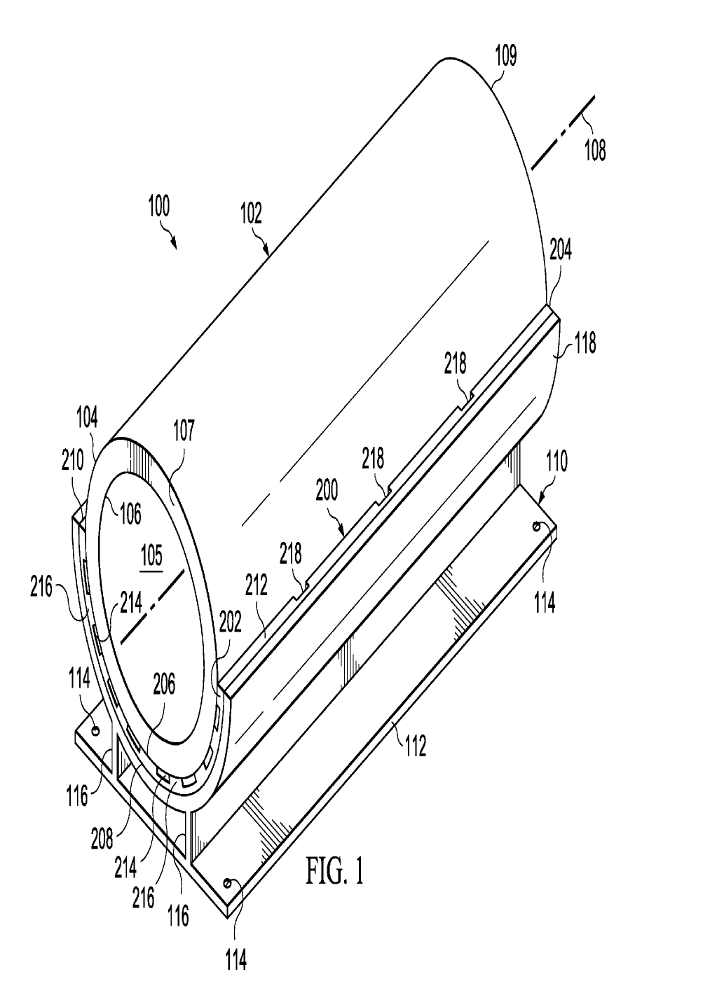

Referring now to FIG. 1, an oblique view of a pipeline corrosion control system 100 is shown according to an embodiment of the disclosure. The pipeline corrosion control system 100 generally comprises a pipeline 102, a saddle assembly 110, and a support liner 200. The pipeline 102 has a substantially cylindrically shaped outer surface 104 positioned about a central axis 108. The pipeline 102 also has a substantially cylindrically-shaped central bore 105 that extends longitudinally through the pipeline 102 along the central axis 108 forming a substantially complimentary-shaped inner surface 106. The difference between the outer surface 104 and the inner surface 106 is commonly referred to as the pipeline thickness or pipe wall thickness. In some embodiments, the outer surface 104 and the inner surface 106 have a substantially similarly-shaped profile, such that the pipe wall thickness is substantially uniform. In some embodiments, the pipeline 102 may include an insulative material, such as a rigid foam insulation, disposed between the outer surface 104 and the inner surface 106 of the pipeline 102.

The pipeline 102 is configured to carry fluids through the central bore 105 of the pipeline 102 from a first end 107 of the pipeline 102 to a second end 109 of the pipeline 102. The pipeline has a length as measured from the first end 107 to the second end 109 along the central axis 108. The pipeline 102 also has an outer diameter as measured at two opposing locations on the outer surface 104 through the central axis 108. This outer diameter is commonly referred to as the pipe outer diameter (OD). In some embodiments, the outer diameter of the pipeline 102 may be at least about 3 inches (about 7.6 centimeters). However, in alternative embodiments, the pipeline 102 may comprise a diameter that exceeds 3 inches (about 7.6 centimeters). Additionally, the pipeline 102 has an inner diameter as measured at two opposing locations on the inner surface 106 through the central axis 108. This inner diameter is commonly referred to as the pipe inner diameter (ID) or bore diameter of the pipeline 102.

The saddle assembly 110 generally includes a saddle base 112 and a saddle 118. As illustrated, the saddle base 112 has a plurality of saddle mounting holes 114 disposed in the saddle base 112 configured to accept mounting hardware for securing the saddle assembly 110 to a fixed support structure. In some embodiments, the saddle assembly 110 is configured to mount to a fixed support structure such as a concrete base. However, any other fixed support structure configured to support the weight and/or any movement of the pipeline corrosion control system 100 and capable of accepting the saddle assembly will suffice. The saddle assembly 110 may also comprise a plurality of saddle risers 116. As illustrated in FIG. 1, at least one saddle riser 116 extends perpendicularly from the saddle base 112 to the saddle 118 and is configured to support the saddle 118 and/or the pipeline 102. In some embodiments, the saddle assembly 110 may comprise at least two saddle risers 116 disposed on each of a first side and a second side of the central axis 108 and/or a center of the pipeline 102. In some embodiments, the saddle assembly 110 may comprise any number of saddle risers 116 as a result of the size of the pipeline 102, the weight of the pipeline 102 and/or the saddle 118, and/or the volume of fluid flowing through the pipeline 102.

As stated, the saddle 118 may be offset from and attached to the saddle base 112 by a plurality of saddle risers 116. As illustrated, the saddle 118 is configured as a substantially arc-shaped receptacle upwardly open and configured to receive at least a portion of the pipeline 102. The saddle 118 has a profile that is substantially similar and/or complimentary to the profile of the outer surface 104 of the pipeline 102. In some embodiments, the saddle 118 has a radius that is substantially similar to the radius of the outer surface 104 of the pipeline 102. Furthermore, the saddle 118 may also be configured to support the pipeline 102 and/or restrict lateral movement of the pipeline 102 with respect to the saddle 118 and/or the saddle assembly 110 when the pipeline 102 is received by the saddle 118. The saddle 118 may also be configured to accept a support liner 200 disposed between the saddle 118 and the pipeline 102.

In the illustrated embodiment, the support liner 200 has a first end 202, a second end 204 disposed at an opposing distal end from the first end 202, a top side 206 associated with the pipeline 102, a bottom side 208 associated with the saddle 118, a first side 210 associated with a left side, and a second side 212 associated with a right side. The top side 206 of the support liner 200 is associated with the pipeline 102, while the bottom side 208 is associated with the saddle 118. As illustrated, the support liner 200 has a substantially rectangular shape capable of being positioned in the saddle 118 and disposed between the saddle 118 and the pipeline 102. The support liner 200 may be formed from a substantially pliable and/or flexible material, such that when the support liner 200 is positioned in the saddle 118, the support liner 200 configured to conform to the arc-shape of the saddle 118, such that the bottom side 208 of the support liner 200 substantially abuts and/or is in substantially uniform contact with the saddle 118.

Additionally, when the support liner 200 is positioned in the saddle 118, it is preferably flexibly configured to conform to the profile of the outer surface 104 of the pipeline 102. In this embodiment the support liner 200 conforms to inconsistencies in the outer surface 104 of the pipeline 102, since the pipeline 102 may not be perfectly round due to the flexibility of the galvanized metallic outer surface 104 and/or the insulation present between the outer surface 104 and the inner surface 106. In some embodiments, by conforming to any deformations and/or inconsistencies in the outer surface 104 and/or insulation of the pipeline 102, the support liner 200 may provide greater support to the pipeline 102 and/or a more uniform fitment between the pipeline 102 and the saddle 118 as compared to a pipeline system that does not employ an elastomeric support liner 200 or a pipeline system that employs a substantially rigid liner.

Because pipeline system components are capable of operating in damp conditions, one preferred wet static coefficient of friction for the support liner 200 is about 0.35. In some embodiments, the support liner 200 may be formed from a flexible, elastomeric material (i.e. natural rubber, butyl rubber, nitrile rubber, or similar elastomeric material) having a wet static coefficient of friction of at least about 0.7. Accordingly, a support liner 200 having an elastomeric material provides increased motion control between the pipeline 102 and the saddle 118. In some embodiments, a support liner 200 comprising an elastomeric material isolates small disturbances caused by flowing fluids through the pipeline 102 and/or small vibrations between the pipeline 102 and the saddle 118. Thus, by providing an elastomeric support liner 200 that controls and/or reduces the corrosion-enhancing effects of relative motion between the pipeline 102 and the saddle 118, corrosion between the pipeline 102 and the saddle 118 is controlled and/or reduced. Additionally, because the pipeline corrosion control system 100 will be exposed to varying extreme temperature conditions, the elastomeric support liner 200 is configured to support in temperature conditions ranging from about −65° F. to about 140° F. (about −54° C. to about 60° C.).

As illustrated, the support liner 200 has a plurality of longitudinal grooves 214 and a plurality of lateral grooves 218. The longitudinal grooves 214 are disposed in the top side 206 of the support liner 200 and extend from the first end 202 to the second end 204 of the support liner 200. In some embodiments, the longitudinal grooves 214 are evenly distributed and/or spaced along the top side 206 of the support liner 200. However, in other embodiments, the longitudinal grooves 214 may comprise any different arrangement that may promote better corrosion resistance and/or vibration control of the pipeline 102. The lateral grooves 218 are disposed in the top side 206 of the support liner 200 and extend from the first side 210 to the second side 212 of the support liner 200. In some embodiments, the lateral grooves 218 are evenly distributed along the top side 206 of the support liner 200. In other embodiments, the lateral grooves 218 may comprise any different arrangement that may promote better corrosion resistance and/or vibration control of the pipeline 102. The arrangement of the longitudinal grooves 214 and the lateral grooves 218 produce an arrangement of protrusions 216 capable of contacting the pipeline 102 and that are configured to support the pipeline 102. In some embodiments, the longitudinal grooves 214 and/or the lateral grooves 218 allow moisture to drain and/or evaporate, thereby preventing moisture from collecting between the saddle 118 and the pipeline 102. This action reduces and/or eliminates corrosion of the saddle 118 and/or the pipeline 102.

Referring now to FIGS. 2 and 3, an orthogonal cross-sectional front view and an orthogonal top view of the support liner 200 are illustrated, respectively. The support liner 200 has a width defined as the distance between the first side 210 and the second side 212. In some embodiments, the width of the support liner 200 is substantially equal to an arc length of the saddle 118, such that the support liner 200 substantially fits within the saddle 118. In some embodiments, the support liner 200 has a width selected based on the size of the pipeline 102. The support liner 200 has a length that is defined as the distance between the first end 202 and the second end 204. In some embodiments, the length of the support liner 200 is substantially equal to the length of the saddle 118 and/or the length of the pipeline 102 that the support liner 200 and/or the saddle 118 is designed to support. However, in other embodiments, the length of the support liner 200 may be any other selected length commensurate with the length of the pipeline 102 being supported.

The support liner 200 has a top side 206 with a tapered profile as viewed from either of the first end 202 or the second end 204. The tapered profile generally tapers from a longitudinal center line 220 that is equidistant from the first side 210 and the second side 212. Accordingly, the support liner 200 has a taper angle 230 defined as the angle formed between the tapered top side 206 and the bottom side 208. In some embodiments, the taper angle 230 of the support liner 200 is selected based on the diameter of the pipeline 102. As the tapered top side 206 slopes from the longitudinal center line 220 to each of the first side 210 and the second side 212, the support liner 200 has a minimum thickness at each of the first side 210 and the second side 212. The minimum thickness is measured from the top side 206 to the bottom side 208 at each of the distal ends of the support liner 200. In some embodiments, the minimum thickness at each of the first side 210 and the second side 212 is substantially similar to a base thickness 224. The base thickness is defined as the thickness of the support liner 200 as measured from a groove base 222 of a longitudinal groove 214 and/or a lateral groove 218 to the bottom side 208 of the support liner 200.

The support liner 200 may have a center longitudinal groove 214a disposed at the center of the width of the support liner 200, such that the longitudinal center line 220 substantially bisects the center longitudinal groove 214a. An overall height 236 of the support liner 200 is the distance as measured at the highest point of each of the protrusions 216 disposed adjacent to the center longitudinal groove 214a and/or the longitudinal centerline 220 from the top side 206 to the bottom side 208. Still further, the overall height 236 as measured at each of the protrusions 216 located substantially adjacent to the center longitudinal groove 214a may also be referred to as a maximum thickness. In some embodiments, the support liner 200 has an overall height 236 (maximum thickness) of at least about one-half (0.5) inch (about 1.3 centimeters). In other embodiments, the overall height 236 of the support liner 200 is determined by the size of the pipeline 102.

The support liner 200 has a plurality of longitudinal grooves 214 disposed in the top side 206 of the support liner 200 extending from the first end 202 to the second end 204 of the support liner 200. The support liner 200 may have a center longitudinal groove 214a disposed substantially in the center of the width of the support liner 200, such that the longitudinal center line 220 substantially bisects the center longitudinal groove 214a. The longitudinal grooves 214 have a longitudinal groove width 226 and are spaced along the width of the support liner 200 from other adjacent longitudinal grooves 214 by a longitudinal groove pitch 228. In some embodiments, the longitudinal grooves 214 have a substantially similar and/or substantially equal longitudinal groove width 226. By way of a non-limiting example, in some embodiments, the longitudinal grooves 214 have a longitudinal groove width 226 of about one-half (0.5) inch (about 1.3 centimeters). In other embodiments, the longitudinal grooves 214 may have a longitudinal groove width 226 of about 0.25 inch, 0.375 inch, 0.625 inch, 0.75 inch, and/or 1 inch (about 0.65 centimeters, 0.95 centimeters, 1.6 centimeters, 1.9 centimeters, and/or 2.54 centimeters). However, in other embodiments, the longitudinal grooves 214 may comprise substantially variable longitudinal groove widths 226. In some embodiments, the longitudinal grooves 214 may be evenly distributed and/or spaced along the width of the support liner 200 such that the longitudinal groove pitch 228 remains constant across the support liner 200. However, in other embodiments, the support liner 200 may comprise a variable longitudinal groove pitch 228 between adjacently located longitudinal grooves 214.

The longitudinal grooves 214 are disposed in the top side 206 of the support liner 200 and have a groove base 222 that is substantially parallel to the bottom side 208 of the support liner 200. Additionally, longitudinal grooves 214 are disposed closer to the longitudinal center line 220 and/or the center longitudinal groove 214a have a groove depth that is deeper than an adjacent longitudinal groove 214 disposed further from the longitudinal center line 220 and/or the center longitudinal groove 214a. In some embodiments each longitudinal groove 214 has a base thickness 224 that is substantially equal. Furthermore, the base thickness 224 may be substantially equal to the minimum thickness of the support liner 200 as measured from the top side 206 to the bottom side 208 at each of the first side 210 and the second side 212. In some embodiments, the base thickness 224 remains constant throughout the longitudinal grooves 214 and the lateral grooves 218.

The support liner 200 has a plurality of lateral grooves 218 disposed in the top side 206 of the support liner 200 extending from the first side 210 to the second side 212. The lateral grooves 218 are disposed substantially perpendicular to the longitudinal grooves 214. In some embodiments, the lateral grooves 218 are disposed at an angle that is not perpendicular to the longitudinal grooves 214. The lateral grooves 218 have a lateral groove width 238 and are spaced along the length of the support liner 200 from other adjacent lateral grooves 218 by a lateral groove pitch 240. In some embodiments, the lateral grooves 218 have a substantially similar and/or substantially equal lateral groove width 238. In some embodiments, the lateral grooves 218 have a substantially similar lateral groove width 238 to the longitudinal groove width 226. For example, in some embodiments, the lateral grooves 218 have a lateral groove width 238 of about one-half (0.5) inch (about 1.3 centimeters). In other embodiments, the lateral grooves 218 may have a lateral groove width 238 of about ¼ inch, ⅜ inch, ⅝ inch, ¾ inch, and/or 1 inch (about 0.65 centimeters, 0.95 centimeters, 1.6 centimeters, 1.9 centimeters, and/or 2.54 centimeters). In some embodiments, the lateral grooves 218 are evenly distributed and/or spaced along the length of the support liner 200 such that the lateral groove pitch 240 remains constant across the support liner 200. However, in other embodiments, the support liner 200 may comprise a variable lateral groove pitch 240.

The arrangement of the longitudinal grooves 214 and the lateral grooves 218 produces an arrangement of protrusions 216 that are configured to contact the pipeline 102 and provide support to the pipeline 102. The arrangement of protrusions 216 may also control the motion of the pipeline 102 relative to the saddle 118 when the support liner 200 is installed in the pipeline corrosion control system 100 of FIG. 1. The longitudinal grooves 214 define a protrusion width 232, while the lateral grooves 218 define a protrusion length 234. In embodiments where the longitudinal groove width 226 and/or the longitudinal groove pitch 228 of the longitudinal grooves 214 remains substantially similar, each protrusion 216 has a substantially similar protrusion width 232. Similarly, in embodiments where the lateral groove width 238 and/or the lateral groove pitch 240 of the lateral grooves 218 remains substantially similar, each protrusion 216 has a substantially similar protrusion length 234.

Referring back to FIG. 1 in conjunction with FIGS. 2 and 3, when the support liner 200 is installed in the pipeline corrosion control system 100 of FIG. 1, the support liner 200 is disposed between the saddle 118 and the pipeline 102. The width of the support liner 200 is oriented along a partial circumference of the saddle 118 and/or the pipeline 102, while the length of the support liner 200 is oriented along a supported length of the pipeline 102 and/or a length of the saddle 118. The pipeline 102 is supported by the protrusions 216, while the longitudinal grooves 214 and the lateral grooves 218 form channels between the pipeline 102 and the groove base 222 of the grooves 214, 218. The protrusions 216 of the support liner 200 are configured to conform to the profile of the outer surface 104 of the pipeline 102, since the pipeline 102 may not be perfectly round due to the flexibility of the galvanized metallic outer surface 104 and/or the insulation present between the outer surface 104 and the inner surface 106. Additionally, the protrusions 216 are interstitially spaced and are located between adjacent longitudinal grooves 214, thereby also providing enhanced motion control between the pipeline 102 and the saddle 118. The flexible, elastomeric protrusions 216 are allowed to deform and occupy space within the grooves 214. Thus, the support liner 200 may reduce and/or eliminate corrosion-enhancing vibrations and/or relative movements between the pipeline 102 and the saddle 118. Furthermore, the longitudinal grooves 214 and/or the lateral grooves 218 are configured to allow moisture to drain and/or evaporate, which prevents moisture from collecting between the saddle 118 and the pipeline 102, thus reducing and/or eliminating corrosion of the saddle 118 and/or the pipeline 102.

In one embodiment, the support liner 200 is designed to be installed between a pipeline 102 and a saddle 118 having a substantially similar radius. The thickness of the support liner 200 may displace the pipeline 102 in a vertical direction with respect to the saddle 118, when the pipeline 102 and the saddle 118 comprise substantially similar radii. In this case, the distance between a lowest bottom portion of the pipeline 102 and a lowest bottom portion of the saddle 118 may be greater than the distance between a side of the pipeline 102 and a respective side of the saddle 118. Accordingly, the tapered profile of the top side 206 of the support liner 200 may accommodate the variations in distance between the pipeline 102 and the saddle 118 when the support liner 200 is installed and/or disposed between the similar-radiused pipeline 102 and saddle 118. This allows for a substantially uniform contact between the pipeline 102 and the tapered top side 206 of the support liner 200. Additionally, the substantially flat bottom side 208 of the support liner 200 allows substantially uniform contact between the saddle 118 and the bottom side 208 of the support liner 200.

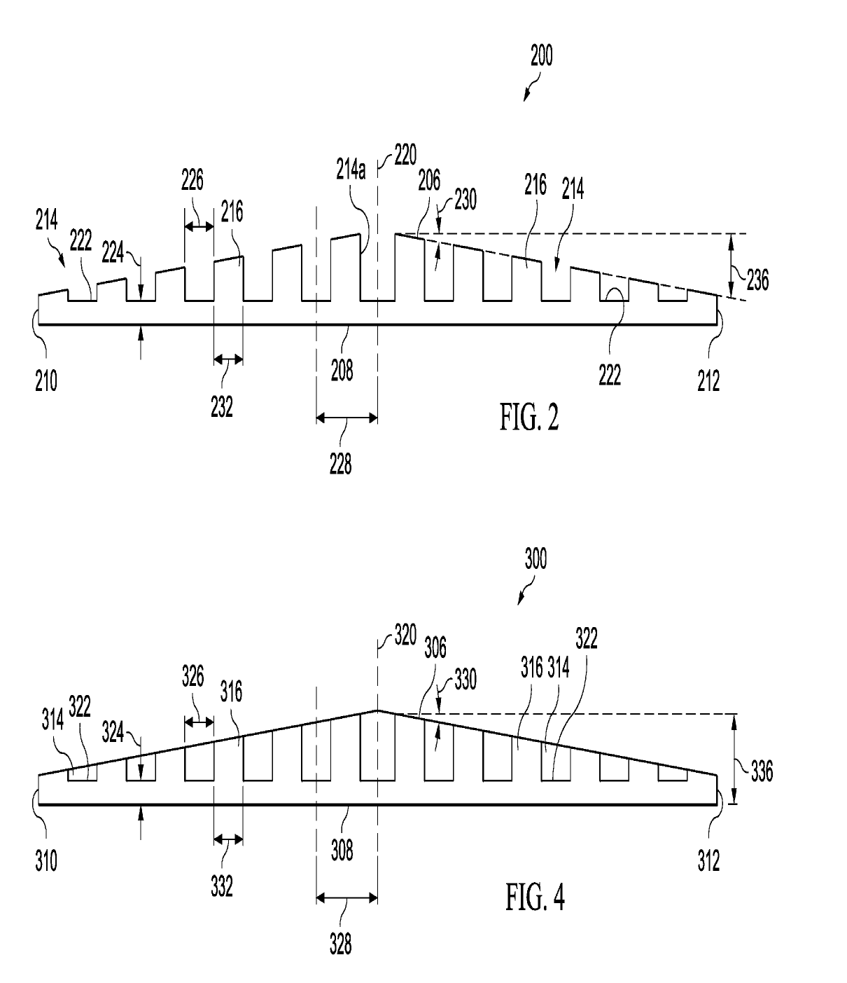

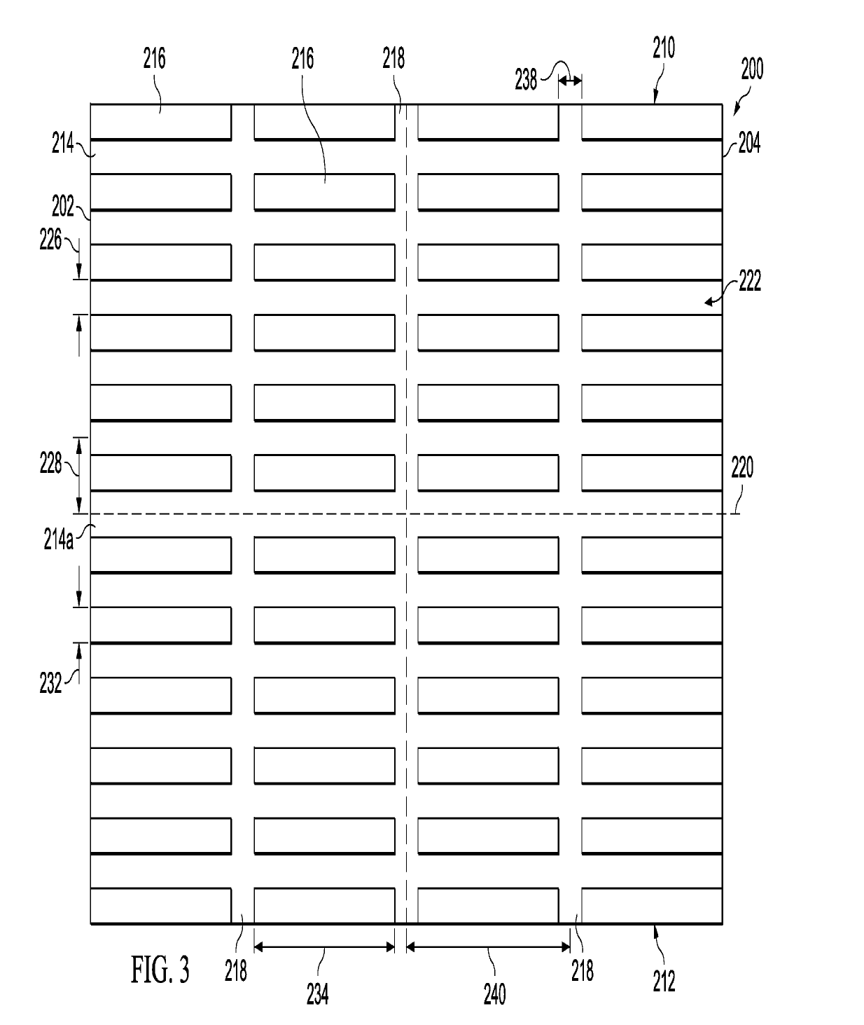

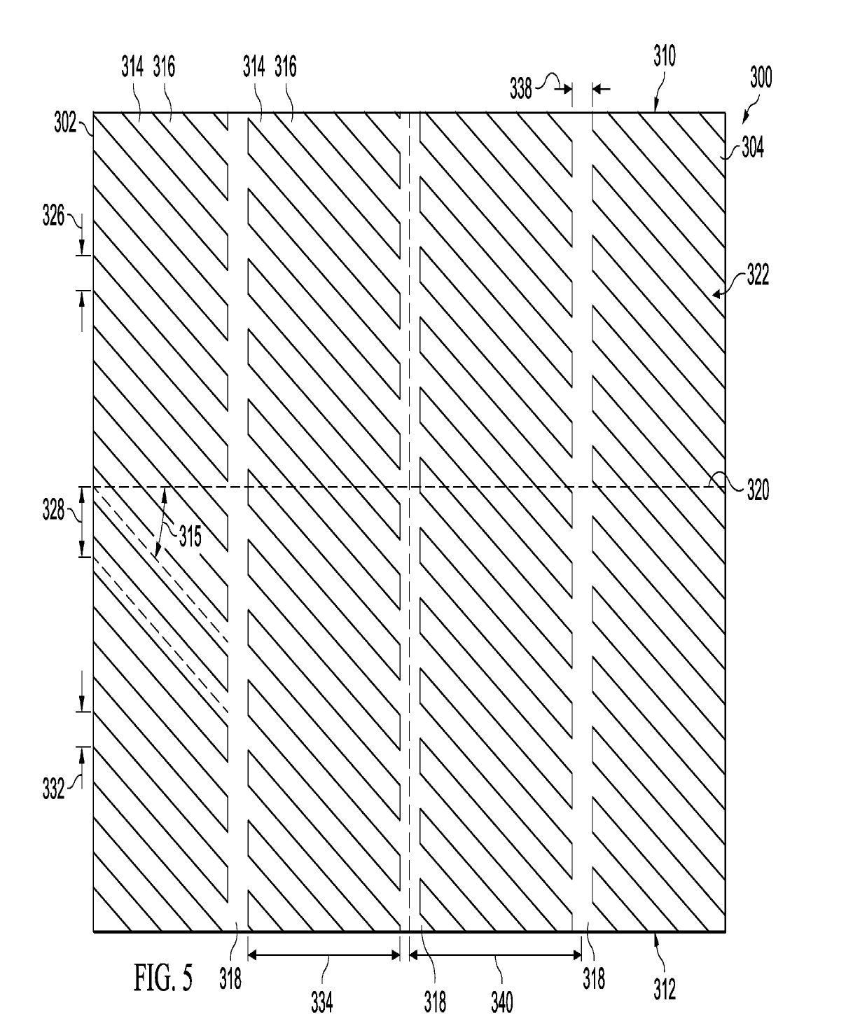

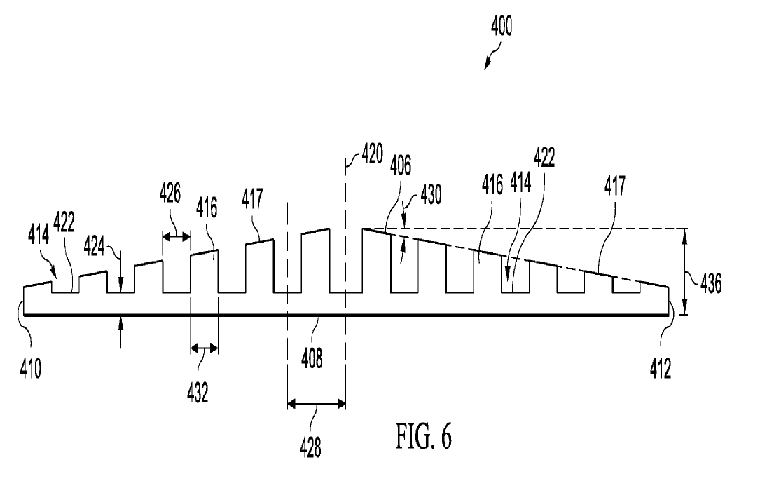

Referring now to FIGS. 4 and 5, an orthogonal cross-sectional front view and an orthogonal top view of a support liner 300 are illustrated, respectively. Support liner 300 is substantially similar to support liner 200 of FIGS. 1-3 and has a first end 302, a second end 304 disposed at an opposing distal end from the first end 302, a tapered top side 306, having a taper angle 330 and extending to each of a left side 310 and a right side 312 from a longitudinal center line 320, a substantially flat bottom side 308, a left side 310, and a right side 312. Support liner 300 has a plurality of protrusions 316 extending from a groove base 322, a substantially uniform base thickness 324, and a plurality of lateral grooves 318 having a lateral groove width 338 and a lateral groove pitch 340. Furthermore, support liner 300 is configured for use in the pipeline corrosion control system 100 of FIG. 1. However, support liner 300 has a plurality of angled longitudinal grooves 314 comprising a groove angle 315 as opposed to the substantially lengthwise longitudinal grooves 214 of FIGS. 1-3.

The angled longitudinal grooves 314, instead of extending from the first end 302 to the second end 304, are generally oriented at a groove angle 315. The groove angle 315 is an angle that the angled longitudinal groove 314 is oriented with respect to at least one of the left side 310, the right side 312, and/or the longitudinal center line 320. The angled longitudinal grooves 314 are generally oriented at an angle relative to the longitudinal center line 320 that is greater than 0° and less than 90°. In some embodiments, the groove angle 315 may be at least about 15 degrees, at least about 30 degrees, at least about 45 degrees, at least about 60 degrees, and/or at least about 75 degrees. The angled longitudinal grooves 314 have a longitudinal groove width 326 and are spaced along the width of the support liner 300 from other adjacent angled longitudinal grooves 314 by a longitudinal groove pitch 328. The longitudinal groove width 326 of the angled longitudinal grooves 314 includes the width of one of the angled longitudinal grooves 314 as measured along the first end 302 and/or the second end 304, while the longitudinal groove pitch 328 includes the distance between adjacent angled longitudinal grooves 314 as measured along the first end 302 and/or the second end 304.

In some embodiments, the angled longitudinal grooves 314 have a substantially similar and/or substantially equal longitudinal groove width 326. By way of a non-limiting example, the angled longitudinal grooves 314 may comprise a longitudinal groove width 326 of about one-half (0.5) inch (about 1.3 centimeters). In other embodiments, the angled longitudinal grooves 314 may comprise a longitudinal groove width 326 of about ¼ inch, ⅜ inch, ⅝ inch, ¾ inch, and/or 1 inch (about 0.65 centimeters, 0.95 centimeters, 1.6 centimeters, 1.9 centimeters, and/or 2.54 centimeters). However, in other embodiments, the angled longitudinal grooves 314 have substantially variable longitudinal groove widths 326. In some embodiments, the angled longitudinal grooves 314 are evenly distributed and/or spaced along the width of the support liner 300 such that the longitudinal groove pitch 328 remains constant across the support liner 300. However, in other embodiments, the support liner 300 has a variable longitudinal groove pitch 328, such that the angled longitudinal grooves 314 are spaced at variable distances from adjacent angled longitudinal grooves 314 across the width of the support liner 300.

The arrangement of the angled longitudinal grooves 314 and the lateral grooves 318 produces an arrangement of protrusions 316 configured to contact the pipeline 102 and provide support to the pipeline 102 and/or control the motion of the pipeline 102 relative to the saddle 118 when the support liner 300 is installed in the pipeline corrosion control system 100 of FIG. 1. The angled longitudinal grooves 314 have a protrusion width 332 defined as the width of each protrusion 316 as measured along the first end 302 and/or the second end 304. The lateral grooves 318 have a protrusion length 334 defined as the length of each protrusion 316 as measured along the left side 310 and/or the right side 312. In embodiments where the longitudinal groove width 326 and/or the longitudinal groove pitch 328 of the angled longitudinal grooves 314 remains substantially similar, each protrusion 316 has a substantially similar protrusion width 332. Similarly, in embodiments where the lateral groove width 338 and/or the lateral groove pitch 340 of the lateral grooves 318 remains substantially similar, each protrusion 316 has a substantially similar protrusion length 334.

The angled longitudinal grooves 314 are configured to allow trapped moisture to drain and/or evaporate. In some embodiments, the angled longitudinal grooves 314 provide enhanced drainage by using the angled longitudinal grooves 314 oriented at a groove angle 315 around the circumference of the pipeline 102. However, in some embodiments, the groove angle 315 is selected as a result of the environment that the support liner 300 is designed for use and/or the size of the pipeline 102. Alternatively, while this embodiment depicts angled longitudinal grooves 314, in other embodiments, the lateral grooves 318 are oriented at the groove angle 315 while the angled longitudinal grooves 314 are substantially parallel to the left side 310 and/or the right side 312 and comprise a groove angle 315 of substantially zero.

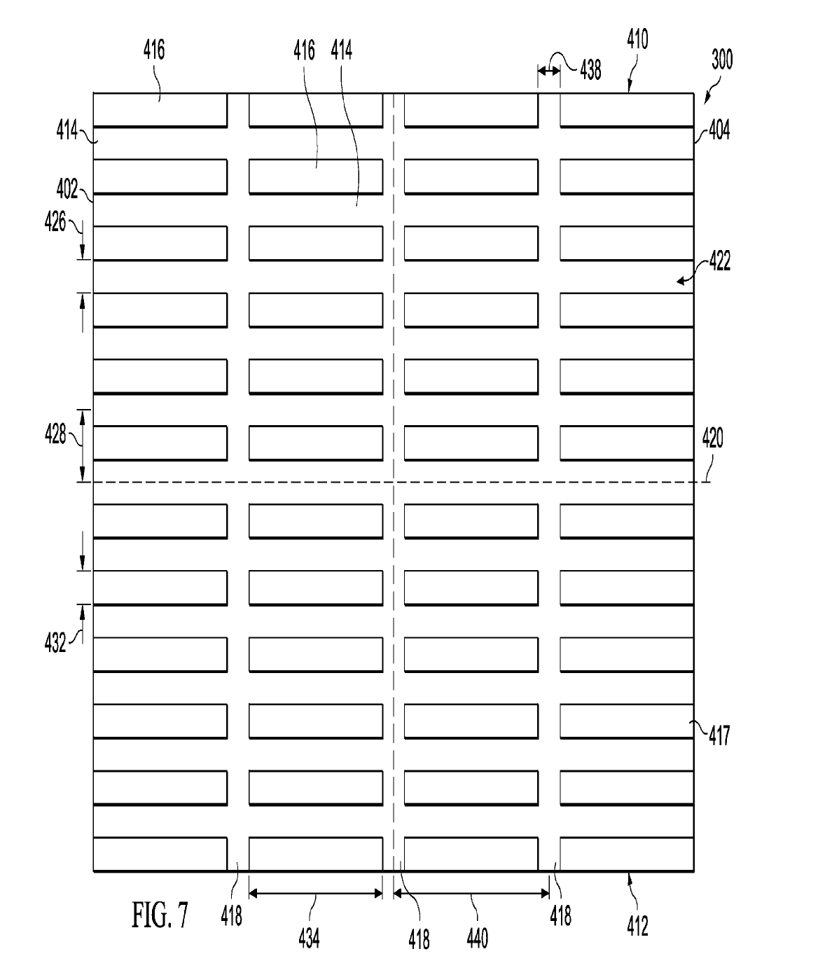

Referring now to FIGS. 6 and 7, an orthogonal cross-sectional front view and an orthogonal top view of a support liner 400 are shown, respectively. Support liner 400 is substantially similar to support liner 200 of FIGS. 1-3 and includes a first end 402, a second end 404 disposed at an opposing distal end from the first end 402, a tapered top side 406 having a taper angle 430 and extending to each of a left side 410 and a right side 412 from a longitudinal center line 420, a substantially flat bottom side 408, a left side 410, and a right side 412. Support liner 400 has a plurality of longitudinal grooves 414 including a longitudinal groove width 426 and a longitudinal groove pitch 428, a plurality of lateral grooves 418 having a lateral groove width 438 and a longitudinal groove pitch 440, a substantially uniform base thickness 424, and a plurality of protrusions 416 having a protrusion width 432 and a protrusion length 434 extending from a substantially uniform groove base 422. Furthermore, support liner 400 is configured for use in the pipeline corrosion control system 100 of FIG. 1. However, while the support liner 400 has a tapered profile, the protrusions 416 include substantially flat protrusion tops 417 as opposed to the substantially tapered tops of the support liners 200, 300 of FIGS. 1-3 and 4-5, respectively.

The protrusion tops 417 are configured as substantially flat, truncated surfaces. The protrusion tops 417 are oriented substantially parallel to the groove base 422 and/or the bottom side 408 of the support liner 400. The top side 406 of the support liner 400 may be referred to as the plurality of substantially flat protrusion tops 417, such that an overall height 436 is measured from the bottom side 408 to a protrusion top 417 that is most adjacent to the longitudinal center line 420. The protrusion tops 417, in this embodiment, are truncated such that when the support liner 400 is installed in the pipeline corrosion control system 100 of FIG. 1, the center of each of the protrusion tops 417 is substantially tangent to the outer surface 104 of the pipeline 102 in FIG. 1. While the protrusion tops 417 are depicted as substantially flat surfaces, in some embodiments, the protrusion tops 417 may be oriented at a slight angle such that the protrusion tops 417 remain substantially tangent to the outer surface 104 of the pipeline. In other embodiments, the protrusion tops 417 may be rounded or have any other shape that prevents trapping moisture and supports the pipeline. Accordingly, an angle of the protrusion tops 417 with respect to the groove base 422 and/or the bottom side 408 is selected as a result of the geometry of the saddle 118 and/or the geometry of the pipeline 102.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A support liner comprising:
a top side; and
a bottom side;
wherein a plurality of grooves are disposed in the top side of the support liner; and
wherein the support liner is formed from an elastomeric material having a wet static coefficient of friction of at least about 0.35.

2. The support liner of claim 1, wherein the elastomeric material is capable of being used in temperatures from about −65° F. (−54° C.) to about 140° F. (60° C.).

3. The support liner of claim 1, wherein the top side comprises a substantially tapered profile.

4. The support liner of claim 3, wherein the bottom side comprises a substantially flat profile.

5. The support liner of claim 1, wherein the plurality of grooves extend from a first end of the support liner to a second end of the support liner along the length of the support liner.

6. The support liner of claim 1, wherein the plurality of grooves extend from a left side of the support liner to a right side of the support liner along the width of the support liner.

7. The support liner of claim 1, wherein at least a portion of the plurality of grooves extend from a first end of the support liner to a second end of the support liner along the length of the support liner, and wherein at least a portion of the plurality of grooves extend from a first end of the support liner to a second end of the support liner along the length of the support liner.

8. The support liner of claim 1, wherein at least a portion of the plurality of grooves are oriented at an angle relative to a longitudinal center line, and wherein the angle is greater than 0° and less than 90° as measured from the longitudinal center line.

9. A pipeline corrosion control system, comprising:
a pipeline;
a saddle; and
a support liner comprising a top side and a bottom side;
wherein a plurality of grooves are disposed in the top side of the support liner; and
wherein the support liner is formed from an elastomeric material having a wet static coefficient of friction of at least about 0.35.

10. The pipeline corrosion control system of claim 9, wherein the elastomeric material is capable of being used in temperatures from about −65° F. (−54° C.) to about 140° F. (60° C.).

11. The pipeline corrosion control system of claim 9, wherein the top side of the support liner comprises a substantially tapered profile.

12. The support liner of claim 11, wherein the bottom side of the support liner comprises a substantially flat profile.

13. The pipeline corrosion control system of claim 12, wherein the tapered top side is associated with the pipeline, and wherein the substantially flat bottom side is associated with the saddle.

14. The pipeline corrosion control system of claim 9, wherein the support liner is disposed between the pipeline and the saddle.

15. The pipeline corrosion control system of claim 9, wherein the plurality of grooves extend from a first end of the support liner to a second end of the support liner along the length of the support liner.

16. The pipeline corrosion control system of claim 9, wherein the plurality of grooves extend from a left side of the support liner to a right side of the support liner along the width of the support liner.

17. The pipeline corrosion control system of claim 9, wherein at least a portion of the plurality of grooves extend from a first end of the support liner to a second end of the support liner along the length of the support liner, and wherein at least a portion of the plurality of grooves extend from a first end of the support liner to a second end of the support liner along the length of the support liner.

18. The pipeline corrosion control system of claim 9, wherein at least a portion of the plurality of grooves are oriented at an angle relative to a longitudinal center line, and wherein the angle is greater than 0° and less than 90° as measured from the longitudinal center line.
